(19) United States
(12) Patent Application Publication
(10) Pub. No.: US 2005/0100992 A1
(43) Pub. Date: May 12, 2005

(54) Computational method for detecting remote sequence homology

(76) Inventor: William Stafford Noble, Seattle, WA (US)

Correspondence Address: BAKER & BOTTS, 30 ROCKEFELLER PLAZA, NEW YORK, NY, 10112, US

(21) Appl. No.: 10/963,916

(22) Filed: Oct. 13, 2004

Related U.S. Application Data
(63) Continuation of application No. PCT/US02/12124, filed on Apr. 17, 2002.

(51) Int. Cl. G06F 17/27

(52) U.S. Cl. 435/69.8

(57) ABSTRACT

The present invention relates to a computation method for detecting remote sequence homologies. The method comprises the following steps: First, a training sequence set of positive and negative examples each having a corresponding binary label is provided together with a database query sequence set (typically large) of unlabeled sequences. Second, each sequence in the training set is converted into a fixed-length vector of real values by computing pairwise sequence similarity scores with respect to the vectorization set to obtain vectorized training sequences each having corresponding binary labels. Third, the vectorized training sequences (along with their binary labels) are used to train a discriminative classification algorithm to obtain a trained discriminative classification algorithm. Fourth, the the database of unlabeled sequences are converted into pairwise score vectors, using the vectorization set to obtain vectorized database sequences. Finally, each vectorized database query sequence is presented to the trained discriminative classification algorithm to produce predicted classifications for the database query sequence.

### BACKGROUND OF INVENTION

One key element in understanding the molecular machinery of the cell is to understand the meaning, and/or function, of each protein encoded in the genome. A very successful means of inferring the function of a previously unannotated protein is via sequence similarity with one or more proteins whose functions are already known. Currently, one of the most powerful such homology detection methods is the SVM-Fisher method of Jaakkola, Diekhans and Haussler (ISMB 2000). This method combines a generative, profile Hidden Markov model (HMM) with a discriminative classification algorithm known as the support vector machine (SVM).

Protein homology detection is a core problem in computational biology. Detecting subtle sequence similarities among proteins is useful because sequence similarity typically implies homology, which in turn may imply functional similarity. The discovery of a statistically significant similarity between two proteins is frequently used, therefore, to justify inferring a common functional role for the two proteins.

Over the past 25 years, researchers have developed a battery of successively more powerful methods for detecting sequence similarities. This development can be broken into four stages.

Early methods looked for pairwise similarities between proteins. Among such algorithms, the Smith-Waterman dynamic programming algorithm [Smith & Waterman “Identification of common molecular subsequences”, Journal of Molecular Biology, 147:195-197 (1981)] is among the most accurate, whereas heuristic algorithms such as BLAST [Altschul et al. “A basic local alignment search tool,” Journal of Molecular Biology 215:403-410 (1990)] and FASTA [Pearson “Rapid and sensitive sequence comparisons with FASTP and FASTA,” Methods in Enzymology 183:63-98 (1985)] trade reduced accuracy for improved computational efficiency.

In the second stage, further accuracy was achieved by collecting aggregate statistics from a set of similar sequences and comparing the resulting statistics to a single, unlabeled protein of interest. Profiles [Gribskov, Lüthy and Eisenberg “Profile analysis,” Methods in Enzymology 183:146-159 (1990)] and hidden Markov models (Hands) [Krogh et al. “Hidden Markov models in computational biology. Applications to protein modeling,” Journal of Molecular Biology 235:1501-1531 (1994) and Baldi et al. “Hidden Markov models (HMM) of biological primary sequence information,” Proc. Natl Acad. Sci. USA 91:1059-1063 (1994)] are two methods for representing these aggregate statistics. These family-based methods allow the computational biologist to infer nearly three times as many homologies as a simple pairwise alignment algorithm [Park et al., Sequence comparisons using multiple sequence to detect three times as many remote homologues as pairwise methods. Journal of Molecular Biology 24:1201-1210 (1998)].

In stage three, additional accuracy was gleaned by leveraging the information in large databases of unlabeled protein sequences. Iterative methods such as PSI-BLAST [Altschul et al. Gapped BLAST and PSI-BLAST: A new generation of protein database search programs. Nucleic Acids Research 25:3389-3402 (1997)] and SAM-T98 [Karplus, Barrett and Hughey, “Hidden Markov models for detecting remote protein homologies,” Bioinformatics 14:846-856 (1998)] improve upon profile-based methods by iteratively collecting homologous sequences from a large database and incorporating the resulting statistics into a central model. All of the resulting statistics, however, are generated from positive examples, i.e., from sequences that are known or posited to be evolutionarily related to one another.

In stage four, additional accuracy was gained by modeling the difference between positive and negative examples. Because the homology task requires discriminating between related and unrelated sequences, explicitly modeling the difference between these two sets of sequences yields an extremely powerful method.

As noted above, the SVM-Fisher method [Jaakkola, Diekhans & Haussler “Using the Fisher kernel method to detect remote protein homologies,” Proceedings of the Seventh International Conference on Intelligent Systems for Molecular Biology, pages 149-158, Menlo Park, Calif. 1999, AAAI Press, and Jaakkola, Diekhans & Haussler “A discriminative framework for detecting remote protein homologies,” Journal of Computational Biology 7:95-114 (2000)], which couples an iterative HMM training scheme with a discriminative classification algorithm known as a support vector machine (SVM) [Vapnik, Statistical Learning Theory “Adaptive and learning systems for signal processing, communications and control” Wiley, N.Y. (1998) and Cristianini & Shawe-Taylor “An Introduction to Support Vector Machines” Cambridge UP, 2000], is currently the most accurate known method for detecting remote protein homologies.

The current work presents an alternative method for SVM-based protein classification. The method uses a discriminative classification algorithm, such as SVM, and a pairwise sequence similarity algorithm such as Smith-Waterman in place of the HMM in the SVM-Fisher method. The resulting algorithm, when tested on its ability to recognize previously unseen families from the Structural Classification of Proteins (SCOP) database, yields significantly better remote protein homology detection than SVM-Fisher, profile HMMs, and PSI-BLAST.

Both the SVM-Fisher method and the method of the present invention consist of two main steps: converting a given set of proteins into fixed-length vectors, and training a discriminative classification algorithm (SVM) from the vectorized proteins. The two methods differ only in the vectorization step.

In the SVM-Fisher method, a protein's vector representation is its gradient with respect to a profile HMM; in the method of the present invention (discriminative classification algorithm-pairwise), the vector is a list of pairwise sequence similarity scores. The pairwise score representation of a protein offers at least three primary advantages over the profile HMM gradient representation.

First, the pairwise score representation is simpler, since it dispenses with the profile HMM topology and parameterization, including training via expectation maximization. Second, pairwise scoring does not require a multiple alignment of the training set sequences. For distantly related protein sequences, a profile alignment may not be possible, if for example the sequences contain shuffled domains. Thus, a collection of pairwise alignments allows for the detection of motif—or domain-sized similarities, even when the entire model cannot be easily aligned. The third advantage of the pairwise score representation is its ability to utilize a negative training set. A profile HMM is trained solely on a collection of positive examples—sequences that are known (or at least believed) to be homologous to one another. The discriminative classification algorithm (e.g. SVM) adds to this model the ability to learn from negative examples as well, by discriminating between the two classes. In the method of the present invention, this discriminative advantage is extended throughout the algorithm, i.e. in the discriminative classification algorithm as well as in the vectorization step. The vector space defined by the pairwise scores includes many dimensions (i.e., sequence similarity scores) that are unrelated to the positive training set. These dimensions, if they contain significant similarity scores, can provide important evidence against a protein belonging to the positive class. For example, if a query sequence is somewhat similar to sequences in the positive class but very similar to several sequences in the negative class, then the slight similarities to the positive class can safely be ignored. In the absence of these negative examples, the classification of such a sequence would remain in doubt.

In addition, the method of the present invention could be applied in an iterative framework using an auxiliary database. In this embodiment, the algorithm first searches the auxiliary database for additional positive and negative examples, selecting only those examples for which the classification is clear. In subsequent iterations, the newly identified positive and negative examples would be incorporated into the training set, and the algorithm would again search the database. This process continues until no new positive or negative examples are identified from the database.

### SUMMARY OF THE INVENTION

In accordance with the present invention there is provided a computational method for detecting remote sequence homology and/or for recognition of protein folds comprising the following steps: First, a training sequence set of positive and negative examples each having a corresponding binary label is provided together with a database query sequence set (typically large) of unlabeled sequences. Second, each sequence in the training set is converted into a fixed-length vector of real values by computing pairwise sequence similarity scores with respect to the vectorization set to obtain vectorized training sequences each having corresponding binary labels. Third, the vectorized training sequences (along with their binary labels) are used to train a discriminative classification algorithm to obtain a trained discriminative classification algorithm. Fourth, the the database of unlabeled sequences are converted into pairwise score vectors, using the vectorization set to obtain vectorized database sequences. Finally, each vectorized database query sequence is presented to the trained discriminative classification algorithm to produce predicted classifications for the database query sequence.

The method of the present invention realizes improved detection of remote sequence homologies and/or improved recognition of protein folds over the previously described methods, i.e. it has been shown to provide remarkably reliable homology detection and protein fold recognition, and to provide accurate detections of remote homologies and protein folds that are not detectable by many of the previously known methods. In addition, the method may be generally applicable to all biopolymer sequences, including, inter alia, RNA sequences, DNA sequences and protein sequences.

### BRIEF DESCRIPTION OF THE DRAWINGS

The present invention will now be described by way of the following detailed description of illustrative embodiments thereof in conjunction with the drawings in which:

FIG. 1 is a flow diagram comparing the SVM-Fisher algorithm (A) and the method of the present invention (B);

FIG. 2 is a flow diagram illustrating an exemplary embodiment of the computational method of the present invention;

FIG. 3(A) is a graph showing the relative performance of seven homology detection methods, including exemplary embodiments of the method of the present invention (SVM-pairwise, SVM-pairwise⁺, and KNN-pairwise), using ROC scores and 3(B) is a graph showing the relative performance of seven homology detection methods, including exemplary embodiments of the method of the present invention, using median RFP scores; and

FIG. 4 shows a family-by-family comparison of Fisher-SVM and an exemplary embodiment of the present invention (SVM-pairwise);

FIG. 5 is a graph showing the relative performance of KNN-pairwise and KNN-Fisher.

### DETAILED DESCRIPTION

The present invention is a novel computational method for detecting remote sequence homologies. Exemplary embodiments of the present invention are referred to herein as “SVM-pairwise,” “SVM-pairwise⁺,” and “KNN-pairwise.” The method of the present invention can detect protein homologies and recognize protein folds. In addition, the method of the present invention may be useful for detecting remote homologies and structural domains among any type of biopolymer sequence, including DNA sequences, RNA sequences as well as protein sequences. It is preferably used to detect homologues among protein sequences. The method of the invention surprisingly improves the efficacy of homology detection and therefore can detect remote homologies that were heretofore not detectable by previously known methods.

The method of the present invention utilizes a discriminative classification algorithm and a pairwise sequence similarity algorithm to detect sequence homologies. The method comprises the following steps: First, a training sequence set of positive and negative examples each having a corresponding binary label is provided together with a database query sequence set (typically large) of unlabeled sequences. Second, each sequence in the training set is converted into a fixed-length vector of real values by computing pairwise sequence similarity scores with respect to the vectorization set to obtain vectorized training sequences each having corresponding binary labels. Third, the vectorized training sequences (along with their binary labels) are used to train a discriminative classification algorithm to obtain a trained discriminative classification algorithm. Fourth, the the database of unlabeled sequences are converted into pairwise score vectors, using the vectorization set to obtain vectorized database sequences. Finally, each vectorized database query sequence is presented to the trained discriminative classification algorithm to produce predicted classifications for the database query sequence.

The discriminative classification algorithm may be any discriminative classification algorithm known in the art, including, but not limited to, a support vector machine (SVM) [see Cristianini & Shawe-Taylor “An Introduction to Support Vector Machines” Cambridge UP, 2000; see also Leslie, Eskin & Noble ‘The spectrum kernel: A string kernel for SVM protein classification” Proceedings of the Pacific Symposium on Biocomputing, 2002], and k-nearest neighbor (KNN) [see Duda, Hart and Stork, “Pattern Classification,” New York, Wiley, 2001; 174-187]. In a preferred embodiment of the invention, the discriminative classification algorithm is SVM. The discriminative classification algorithm can preferably discriminate between positive and negative members of a given class of n-dimensional vectors. Generally, a requirement of a discriminative classification algorithm is that the input be a collection of fixed-length vectors. Biopolymer sequences, e.g. nucleic acid sequences and amino acid sequences, of course, are variable-length sequences. Because they are not of fixed length, they cannot be directly input into a discriminative classification algorithm. Therefore, conversion of the variable length sequences to fixed-length numeric vectors is required. Such a conversion is achieved in the present invention by a pairwise sequence similarity algorithm.

In a preferred embodiment of the present invention, the pairwise sequence similarity algorithm is the Smith-Waterman algorithm. See Smith & Waterman “Identification of common molecular subsequences”, Journal of Molecular Biology, 147:195-197 (1981). In other embodiments of the present invention, the pairwise sequence similarity algorithm may be BLAST [Altschul et al. “A basic local alignment search tool,” Journal of Molecular Biology 215:403-410 (1990)] or FASTP [Pearson “Rapid and sensitive sequence comparisons with FASTP and FASTA,” Methods in Enzymology 183:63098 (1985)]

The discriminative classification algorithm provides the framework of the method of the present invention. As noted above, in a preferred embodiment, the discriminative classification algorithm is the SVM algorithm and can address the general problem of learning to discriminate between positive and negative members of a given class of n-dimensional vectors. The SVM algorithm operates by mapping a given training set (which includes various biopolymer sequences) into a possibly high-dimensional feature space and attempting to locate in that space a plane that separates the positive from the negative examples. Positive examples are sequences that are either known or believed to be homologous to one another, while negative examples are sequences known not to be homologous. Having found a plane that separates the positive from the negative examples by solving a specific quadratic optimization problem, the SVM algorithm can predict the classification of at least one “query sequence” by mapping the query sequence into the feature space and asking on which side of the separating plane the query sequence lies. Along with the classification, the SVM produces a discriminant score, which is proportional to the query sequence's distance from the hyperplane.

As indicated above, the SVM algorithm is a preferred discriminative classification algorithm of the present invention. Support Vector Machines (SVMs) are a class of supervised learning algorithms first introduced by Vapnik (Statistical Learning Theory Springer, 1998 Wiley). Given a set of labeled training vectors (positive and negative input examples), SVMs learn a linear decision boundary to discriminate between the two classes. The result is a linear classification rule that can be used to classify new test examples. SVMs have exhibited excellent generalization performance (accuracy on test sets) in practice and have strong theoretical motivation in statistical learning theory. The following is an example of how an SVM is applied:

If the training set S consists of labeled input vectors (xᵢ, yᵢ), i=1 . . . m, where xᵢε [symbol] ⁿ and yᵢε {±1}. A linear classification rule ƒ can be specified by a pair (w,b), where w ε [symbol] ⁿ and b ε [symbol] , via Equation 1:
ƒ(x)=<w,x>+b, (1)
where a point x is classified as positive (negative) if ƒ(x)>0(ƒ(x)<0). Geometrically, the decision boundary is the hyperplane defined by Equation 2
{x ε Rⁿ:<w,x>+b=0}, (2)
where w is a normal vector to the hyperplane and b is the bias. If it is further required that |w|=1, then the geometric margin of the classifier with respect to S defined by Equation 3:
mₛ^{g}(ƒ)=Min_{{x}_{ᵢ}_{εS}}yif(xᵢ). (3)

In the case where the training data are linearly separable and a classifier f correctly classifies the training set, then
mₛ^{g}(ƒ)
is simply the distance from the decision hyperplane to the nearest training point(s).

In practice, training sets are usually not linearly separable, and the SVM optimization problem must be modified to incorporate a trade-off between maximizing geometric margin and minimizing some measure of classification error on the training set. A formulation of various soft margin approaches is described by Cristianini and Shawe-Taylor (“An Introduction to Support Vector Machines” Cambridge, 2000).

As used herein, a query sequence is a biopolymer sequence for which homology detection is desired. The query sequence may be any biopolymer sequence of any length and may be either a previously described sequence or a newly identified sequence. The query sequence may comprise a full length biopolymer sequence or may be a fragment thereof Part of the SVM algorithm's power lies in its criterion for selecting a separating plane when many candidate planes exist: the SVM algorithm chooses the plane that maintains a maximum margin from any point in the training set. Statistical Learning theory suggests that, for some classes of “well-behaved” data, the choice of the maximum margin hyperplane will lead to maximal generalization when predicting the classification of previously unseen examples. See Vapnik, Statistical Learning Theory “Adaptive and learning systems for signal processing, communications, and control,” Wiley, N.Y., 1998. The discriminative classification algorithm of the present invention, and particularly the SVM algorithm, can be extended to cope with noise in the training set and with multiple classes. See Cristianini & Shawe-Taylor. An Introduction to Support Vector Machines. Cambridge UP, 2000.

As noted above, one important requirement of the discriminative classification algorithm is that the input be a collection of fixed-length vectors and since biopolymer sequences are variable in length, they cannot be directly input to the standard discriminative classification algorithm. In the previously described SVM-Fisher method, the HMM (Hidden Markov model) provides the necessary means of converting protein sequences into fixed-length vectors. See Jaakkola Diekhans & Haussler, “Using the Fisher kernel method to detect remote protein homologies,” Proceedings of the Seventh International Conference oil Intelligent Systems for Molecular Biology, pages 149-158, Menlo Park, Calif. 1999 AAAI Press; see also Jaakkola, Diekhans & Haussler, “A discriminative framework for detecting remote protein homologies,” Journal of Computational Biology, 7(1-2):95-114, 2000. This is accomplished as follows: First, the HMM is trained using the positive members of the training set. Then the gradient vector of any sequence positive, negative or unlabeled, can be computed with respect to the trained model. Each component of the gradient vector corresponds to one parameter of the BNM. The vector summarizes how different the given sequence is from a typical member of the given protein family. An SVM trained on a collection of positively and negatively labeled sequence gradient vectors learns to classify the sequences very well.

In the present invention, to accomplish a conversion of a biopolymer sequence into a fixed-length numeric vector, a pairwise sequence similarity algorithm is preferred. As noted above, the Smith-Waterman algorithm is preferred. See Smith & Waterman, “Identification of common molecular subsequences,” Journal of Molecular Biology 147:195-197 (1981). The Smith-Waterman algorithm uses dynamic programming to compute the optimal local alignment between a given pair of sequences. Candidate alignments are scored using a BLOSUM substitution matrix [Henikoff & Henikoff, “Amino acid substitution matrices from protein blocks,” Proc. Natl Acad. Sci. USA 89:10915-10919 (1992)] for aligned letters, and using user-defined penalties for gaps in either sequence. In a preferred embodiment, the penalty for opening a new gap is 10, and the penalty for extending a gap is 1. Once the dynamic programming locates the local alignment with the highest score, this score is converted into an E-value by comparing the score to a background distribution. It has been shown [Altschul et al., “A basic local alignment search tool,” Journal of Molecular Biology 215:403-410 (1990)] that the distribution of alignment scores produced by pairwise alignment algorithms such as Smith-Waterman follows an extreme value distribution, the parameters of which can be estimated on the fly from the observed distribution (minus outliers) [Pearson, “Empirical statistical estimates for sequence similarity searches,” Journal of Molecular Biology 276:71-84 (1998)]. The resulting pairwise E-values serve as the input to the SVM: each sequence in the training set is represented as a vector of E-values computed with respect to each member in the training set.

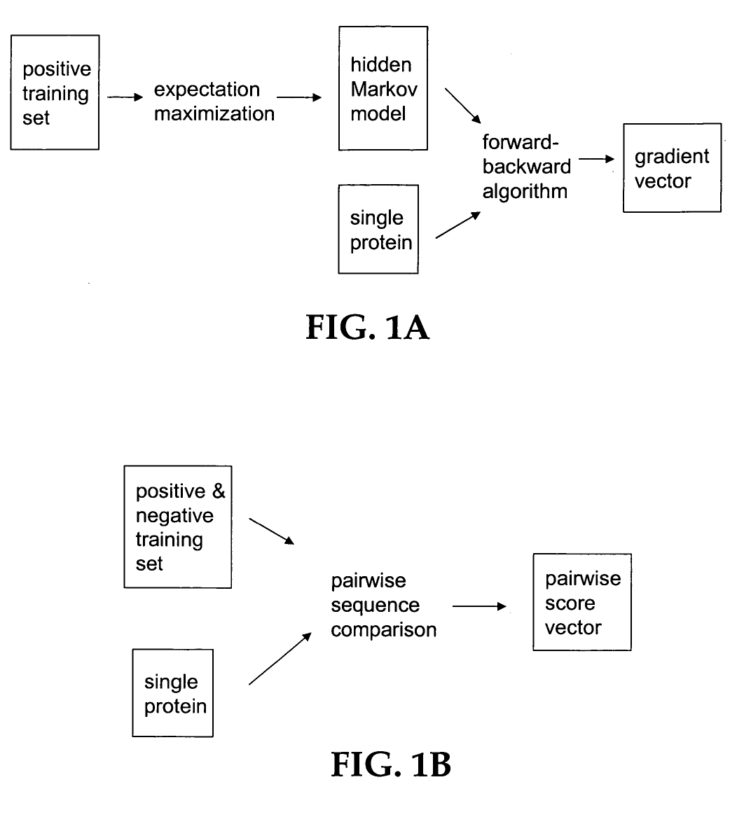

FIGS. 1A and 1B shows the differences between a preferred embodiment of the present invention, SVM-pairwise, and SVM-Fisher. Immediately obvious from FIGS. 1A and 1B is that the method of the present invention (represented by FIG. 1A) simultaneously inputs the training set (which may comprise both positive and negative examples) and the query sequence(s) to the pairwise sequence similarity algorithm, whereas the SVM-Fisher method (represented by FIG. 1B) accomplishes this in essentially three steps as follows: first expectation maximization is performed for the positive training set which is input into the HMM algorithm, the output of which, together with the query sequence(s) is input into a forward-backward algorithm.

The vectorization step of SVM-pairwise uses the Smith-Waterman algorithm as implemented on a BioXLP hardware accelerator (available at www.cgen.com). The feature vector corresponding to protein X is represented by Equation 4:
Fₓ=fₓ₁, fₓ₂, . . . , fₓₙ, (4)
where n is the total number of sequences in the training set, and fₓᵢ is the logarithm of the p-value of the Smith-Waterman score between the query sequence(s) and the ith training set sequence. The default gap opening penalty and extension penalties of 10 and 0.05, respectively, are used. The gap opening penalty and extension penalty values represent the costs associated with introducing or extending a gap in the alignment between the two pairs of sequences.

The SVM algorithm employs the optimization algorithm described by Jaakkola, Diekhans, & Haussler, “A discriminative framework for detecting remote protein homologies” Journal of Computational Biology, 7:95-114 (2000). The software for the SVM algorithm is available at www.cs.columbia.edu/compbio/svm. At the heart of the SVM is a kernel function that acts as a similarity score between pairs of input vectors. The base SVM kernel is normalized so that each vector has length 1 (as defined in Equation 5) in the feature space; i.e.

This kernel K (-,-) is then transformed into a radial basis kernel \hat{K} (-,-) according to

$$K ( X , Y ) = \frac{X \cdot Y}{\sqrt{( X \cdot X ) ( Y \cdot Y )}} . \qquad ( 5 )$$

Equation 6:

$$\hat{K} ( X , Y ) = {ⅇ}^{\frac{K ( X , X ) - 2 K ( X , Y ) + K ( Y , Y )}{2 {σ}^{2}}} + 1 , \qquad ( 6 )$$

where the width is the median Euclidean distance (in feature space) from any positive training example to the nearest negative example. The constant 1 is added to the kernel in order to translate the data away from the origin. This translation is necessary because the preferred SVM optimization algorithm requires that the separating hyperplane pass through the origin. An asymmetric soft margin is implemented by adding to the diagonal of the kernel matrix a value 0.02*p, where p is the fraction of training set sequences that have the same label (i.e. whether they are negative or positive) as the current sequence. See Brown et al. “Knowledge-based analysis of microarray gene expression data using support vector machines,” Proc. Natl Acad. Sci, USA 97:262-267 (2000). The output of the SVM is a discriminant score that is used to rank the members of the query sequence in relation to the training set.

In a discriminative approach, the objective is to refine the discriminant function L(X) directly using both positive and negative training examples. L(X) is represented by Equation 7:

$$\begin{matrix}L ( X ) = log P ( {H}_{I} \vert X ) \\ = log P ( {H}_{0} \vert X ) \\ = {\sum }_{i : {X}_{i} ∈ {H}_{1}}^{} {λ}_{i} K ( X , Xi ) - {\sum }_{i : {X}_{i} ∈ {H}_{1}}^{} {λ}_{i} K ( X , Xi ) ,\end{matrix} \qquad ( 7 )$$

This expansion could be specified without any reference to the posterior class probabilities P(H₁|X) and P(H₀|X) The sign of the discriminant function determines the assignment of the sequence into hypothesis classes. The contribution, either to positive or negative, of each training set sequence to the decision rule consists of two parts: 1) the overall importance of the training set sequence Xᵢ as summarized with the non-negative coefficient λᵢ and 2) a measure of pairwise similarity between the training set sequence Xᵢ and the new example X, expressed in terms of a kernel function K(Xᵢ, X).

Because the sign of the discriminant function L(X) determines the predicted class for any sequence X, it is desired to have the signs correct and the value separated from zero by a large margin for as many of the training set sequences as possible. This is accomplished as follows. If a margin of 1 is chosen, for example, the objective is to find coefficients λᵢ using Equation 8 and Equation 9 so that:
L(Xᵢ)≧1,Xᵢε H₁ and (8)
L(Xᵢ)≦−1,Xᵢε H₀. (9)
Since any margin, once achieved, can be increased by scaling the λᵢ, to convert this into a constrained maximization problem, additional constraints must be imposed on these coefficients, e.g. 0≦λᵢ≦1. Even with the additional constraints, the solution, is not unique. In order to maximize the margins in a geometrically meaningful way, a quadratic optimization for the SVM algorithm is then applied. Equation 10 represents the quadratic optimization function J(λ):

$$J ( λ ) = {\sum }_{i : {X}_{i} ∈ {H}_{i}}^{} {λ}_{i} ( 2 - L ( {X}_{i} ) ) + {\sum }_{i : {X}_{i} ∈ {H}_{o}}^{} {λ}_{i} ( 2 + L ( {X}_{i} ) ) . \qquad ( 10 )$$

[L(Xᵢ) is a linear function of the λᵢ coefficients]. Subject to standard constraints of the kernel function, the solution to the constrained maximization of J(λ) is unique and can be achieved iteratively. For λᵢ, corresponding to Xᵢε H₁, if this coefficient is unconstrained, it would be updated so that the discriminant function evaluated at Xᵢ (i.e. L(Xᵢ)) after the update would be exactly 1. This give the following updated rule represented by Equation 11:

$${λ}_{i} ← \frac{1 - L ( {X}_{i} ) + {λ}_{i} K ( {X}_{i} , {X}_{i} )}{K ( {X}_{i} , {X}_{i} )} . \qquad ( 11 )$$

L(Xᵢ)=1 holds after this update. However, this ignores the constraints λᵢε [0,1]. Taking these into account, the modified update rule Equation 12 is obtained:

$${λ}_{i} ← f ( \frac{1 - L ( {X}_{i} ) + {λ}_{i} K ( {X}_{i} , {X}_{i} )}{K ( {X}_{i} , {X}_{i} )} ) . \qquad ( 12 )$$

where the function ƒ maintains the constraints: ƒ(z)=0 for z≦0, ƒ(z)=z for 0≦z≦1 and ƒ(z)=1 otherwise. This gives the best approximation to the above update rule that is allowed given the constraint on λᵢ. Proceeding analogously for Xᵢε H₀ the update rule becomes Equation 13:

$${λ}_{i} ← f ( \frac{1 + L ( {X}_{i} ) + {λ}_{i} K ( {X}_{i} , {X}_{i} )}{K ( {X}_{i} , {X}_{i} )} ) . \qquad ( 13 )$$

While the discriminative classification algorithm of the present invention has the advantage that it can learn from both negative and positive examples by discriminating between the two classes and that this discriminative component may be extended into the vectorization step, the ability of the method of the present invention to detect remote protein homologies is not dependent upon such discrimination in the vectorization step. Therefore, in one embodiment of the present invention, the vectorization step can utilize a training sequence set comprising only positive examples. In another embodiment of the present invention, vectorization set can utilize a training sequence set comprising both positive and negative examples.

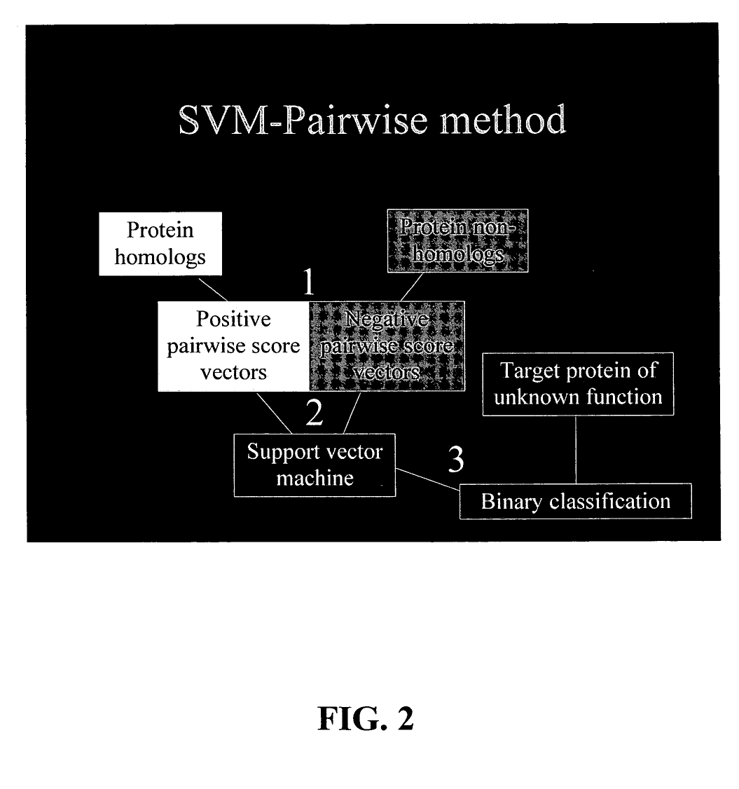

FIG. 2 is a flow diagram showing the steps of an exemplary embodiment of the method of the present invention, termed SVM-pairwise. Referring to FIG. 2, the initial input is a collection of N number of protein domain sequences which is input into step 1 (the pairwise sequence similarity algorithm, preferably the Smith-Waterman algorithm). The output of step 1 is a collection of N length-N vectors consisting of E-values. This output is input into step 2, which is a quadratic optimization of the discriminative classification algorithm, as described above. The output of the quadratic optimization step 2 is a single length-N weight vector. The single length-N weight vector is then input to the discriminative classification algorithm (preferably SVM). The output from the SVM is a single real number, which is positive if the predicted query set sequence is in the positive examples class and negative otherwise.

The following examples are provided to more clearly illustrate the aspects of the invention and are not intended to limit the scope of the invention.

### EXAMPLES

### Example 1

### Comparison of Sequence Homology Detection of SVM-pairwise with 6 Other Algorithms

Methods: The following experiments compare the performance over SVM-pairwise with six other algorithms including SVM-Fisher, PSI-BLAST, SAM, FPS and a simplified version of SVM-pairwise, called SVM-pairwise⁺, and KNN-pairwise. The SVM-pairwise⁺ algorithm is identical to SVM-pairwise, except that the vectorization set of proteins consists of only the positive members of the training set, rather than the entire training set. The KNN-pairwise algorithm replaces the SVM with the k-nearest neighbor algorithm. This discriminative classification algorithm predicts the label of previously unseen test example by a weighted vote among the k training set examples that are closest to the test example. The discriminant value produced by KNN is simply the sum of these votes (1 for positive and −1 for negative), weighted by their distance from the test example. In this implementation, k=3 is used. Table 1 below indicates whether the vectorization set (may also be the training set) used for the seven aforementioned algorithms comprised positive examples or both positive and negative examples.

TABLE 1

| METHOD | TRAIN FROM |
|---|---|
| SVM-pairwise | positive and negative examples |
| SVM-Fisher | positive and negative examples |
| PSI-BLAST | only positive examples |
| SAM | only positive examples |
| FPS | only positive examples |
| KNN-pairwise | positive and negative examples |
| SVM-pairwise⁺ | positive and negative examples |

The recognition performance of each algorithm listed above was assessed by testing its ability to classify protein domains into superfamilies as defined in the Structural Classification of Proteins (SCOP) version 1.53. See Murzin et al, “SCOP: A structural classification of proteins database for the investigation of sequences and structures,” Journal of Molecular Biology 247:536-540 (1995). In this scheme, a superfamily contains sequences for which the degree of sequence similarity is low but the three-dimensional structure provides compelling evidence that the sequences diverged from a common ancestor. Sequences were selected using the Astral database [astral.standford.edu; see Brenner, Koehl and Levitt, “The ASTRAL compendium for sequence and structure analysis,” Nucleic Acids Research 28:254-256 (2000)], removing similar sequences using an E-value threshold of 10⁻²⁵. This purging removes sequences that are slightly similar to one another (i.e. for which one would expect to observe 10-25 such matches by chance in a random database of the given size). This procedure resulted in 4352 distinct sequences, grouped into families and superfamilies. For each family, the protein structural domains within the family are considered positive query sequences, and the protein domains that fall outside the family but within the same super-family are taken as positive training examples. This is accomplished by looking at the SCOP definitions. Members of a superfamily are being recognized by using one family in a superfamily as a test set and the remaining families as the training set. The data set yielded 54 families containing at least 10 family members outside of the family (positive training examples). Negative examples are taken from outside of the positive sequences' fold (SCOP defines the following hierarchy—class, fold, superfamily, family), and are randomly split into train and query sets in the same ratio as the positive examples. Table 2 lists the SCOP families included in the experiments. For each family, the numbers of sequences in the positive and negative training and test sets are listed. The ID is the ID of a SCOP family. The numbers are the numbers of the examples in the positive and negative training and test sets for the family. A sequence is defined as positive by the SCOP database. Then a predication is made to discover whether the SVM-pairwise algorithm classifies it as positive. If it is positive, then it is called a true positive. If it is not, then it is called a false positive, and vice versa for negative examples.

TABLE 2

| | |
|---|---|
| Positive Set | Negative Set |

| ID | Train | Test | Train | Test |
|---|---|---|---|---|
| 1.27.1.1 | 12 | 6 | 2890 | 1444 |
| 1.27.1.2 | 10 | 8 | 2408 | 1926 |
| 1.36.1.2 | 29 | 7 | 3477 | 839 |
| 1.36.1.5 | 10 | 26 | 1199 | 3117 |
| 1.4.1.1 | 26 | 23 | 2256 | 1994 |
| 1.4.1.2 | 41 | 8 | 3557 | 693 |
| 1.4.1.3 | 40 | 9 | 3470 | 780 |
| 1.41.1.2 | 36 | 6 | 3692 | 615 |
| 1.41.1.5 | 17 | 25 | 1744 | 2563 |
| 1.45.1.2 | 33 | 6 | 3650 | 663 |
| 2.1.1.1 | 90 | 31 | 3102 | 1068 |
| 2.1.1.2 | 99 | 22 | 3412 | 758 |
| 2.1.1.3 | 113 | 8 | 3895 | 275 |
| 2.1.1.4 | 88 | 33 | 3033 | 1137 |
| 2.1.1.5 | 94 | 27 | 3240 | 930 |
| 2.28.1.1 | 18 | 44 | 1246 | 3044 |
| 2.28.1.3 | 56 | 6 | 3875 | 415 |
| 2.38.4.1 | 30 | 5 | 3682 | 613 |
| 2.38.4.3 | 24 | 11 | 2946 | 1349 |
| 2.38.4.5 | 26 | 9 | 3191 | 1104 |
| 2.44.1.2 | 11 | 140 | 307 | 3894 |
| 2.5.1.1 | 13 | 11 | 2345 | 1983 |
| 2.5.1.3 | 14 | 10 | 2525 | 1803 |
| 2.52.1.2 | 12 | 5 | 3060 | 1275 |
| 2.56.1.2 | 11 | 8 | 2509 | 1824 |
| 2.9.1.2 | 17 | 14 | 2370 | 1951 |
| 2.9.1.3 | 26 | 5 | 3625 | 696 |
| 2.9.1.4 | 21 | 10 | 2928 | 1393 |
| 3.1.8.1 | 19 | 8 | 3002 | 1263 |
| 3.8.1.3 | 17 | 10 | 2686 | 1579 |
| 3.2.1.2 | 37 | 16 | 3002 | 1297 |
| 3.2.1.3 | 44 | 9 | 3569 | 730 |
| 3.2.1.4 | 46 | 7 | 3732 | 567 |
| 3.2.1.5 | 46 | 7 | 3732 | 567 |
| 3.2.1.6 | 48 | 5 | 3894 | 405 |
| 3.2.1.7 | 48 | 5 | 3894 | 405 |
| 3.3.1.2 | 22 | 7 | 3280 | 1043 |
| 3.3.1.5 | 13 | 16 | 1938 | 2385 |
| 3.32.1.1 | 42 | 9 | 3542 | 759 |
| 3.32.1.11 | 46 | 5 | 3880 | 421 |
| 3.32.1.13 | 43 | 8 | 3627 | 674 |
| 3.32.1.8 | 40 | 11 | 3374 | 927 |
| 3.42.1.1 | 29 | 10 | 3208 | 1105 |
| 3.42.1.5 | 26 | 13 | 2876 | 1437 |
| 3.42.1.8 | 34 | 5 | 3761 | 552 |
| 7.3.10.1 | 11 | 95 | 423 | 3653 |
| 7.3.5.2 | 12 | 9 | 2330 | 1746 |
| 7.3.6.1 | 33 | 9 | 3203 | 873 |
| 7.3.6.2 | 16 | 26 | 1553 | 2523 |
| 7.3.6.4 | 37 | 5 | 3591 | 485 |
| 7.39.1.2 | 20 | 7 | 3204 | 1121 |
| 7.39.1.3 | 13 | 14 | 2083 | 2242 |
| 7.41.5.1 | 10 | 9 | 2241 | 2016 |
| 7.41.5.2 | 10 | 9 | 2241 | 2016 |

This experimental setup is similar to that used by Jaakkola et al., “Using the Fisher kernel method to detect remote protein homologies” Proceedings of the Seventh International Conference on Intelligent System for Molecular Biology pages 149-158, Menlo Park, Calif., 1999, AAAI Press, except for one important difference: the positive training sets used herein do not include additional protein sequences extracted from a large, unlabeled database. As such, the recognition tasks performed herein are more difficult that those used by Jaakkola et al. In principle, any of the seven methods described herein could be applied in an iterative framework using an auxiliary database.

The SVM-pairwise algorithm was implemented as set forth above. The details of the vectorization step (pairwise sequence similarity algorithm) of SVM-pairwise and the details of the SVM algorithm are set forth above and further defined by Equations 1-3.

For the SAM algorithm, Hidden Markov models were trained using the Sequence Alignment and Modeling (SAM) toolkit (available from www.soe.ucse.edu/research/compbio/sam.html). See also Krogh et al., “Hidden Markov models in computational biology: Applications to protein modeling,” Journal of Molecular Biology 235:1501-1531 (1994). Models were built from unaligned positive training set sequences using the local scoring option (“-SW 2”). Then, a 9-component Dirichlet mixture developed by Kevin Karplus (termed byst-4.5-0-3.9 comp, available from www.soe.ucsc.edu/research/compbio/dirichlets) was used according to the teachings of Jaakkola, Diekhans & Haussler, “A discriminative framework for detecting remote protein homologies,” Journal of Computation biology 7:95-114 (2000). Once a model was obtained, the query set sequence(s) are compared to the model by using HMM score (also with the local scoring option). The resulting E-values were used to rank the query set sequence(s). For the SVM-Fisher algorithm, the same trained HMMs were used during the vectorization step. The forward and backward matrices were combined to yield a count of observations for each parameter in the HMM.

For comparison, the widely-used PSI-BLAST algorithm was also tested. See Altschul et al., “Gapped BLAST and PSI-BLAST: A new generation of protein database search programs,” Nucleic Acids Research 25:3389-3402 (1997). It is not very straight forward to directly compare PSI-BLAST because it requires the input of only a single query sequence, whereas several query sequences may be input to other algorithms, including SVM-pairwise, SVM-pairwise⁺, and KNN-pairwise, which are exemplary embodiments of the method of the present invention. The comparison problem was addressed by selecting a positive training set sequence to serve as the initial query sequence. PSI-BLAST was run for one iteration on a database consisting only of the remaining positive training set sequences. An extremely high E-value threshold was applied so that all of the training set sequences were included in the resulting profile. As used herein, the E-value is the expected number of sequences that score as well as or better than the given score in a random database of a given size. This profile was then used for one additional iteration, this time using the test set as a database. The resulting E-values are used to rank the test set sequences. Note that PSI-BLAST is not run on the test set for multiple iterations: this restriction allows a fair comparison with the other, non-iterative methods included in the study.

Family Pairwise Search [Grundy, “Family-based homology detection via sequence comparison,” S. Istrail, P. Pevzner and M. Waterman, editors, Proceedings of the Second Annual International Conference on Computational Molecular Biology, pages 94-100, ACM, 1998; Bailey & Grundy, “Classifying proteins by family using the product of correlated p-values,” S. Istrail, P/Pevzner and M. Waterman, editors, Proceedings of the Third Annual International Conference on Computational Molecular Biology, pages 10-14, ACM, April 1999] is another family-based protein homology detection method that is based upon the BLAST algorithm. A simple form of FPS, called FPS-minp was also tested herein. FPS-minp simply ranks each test set sequence according to the minimum of the BLAST p-values with respect to the positive training set.

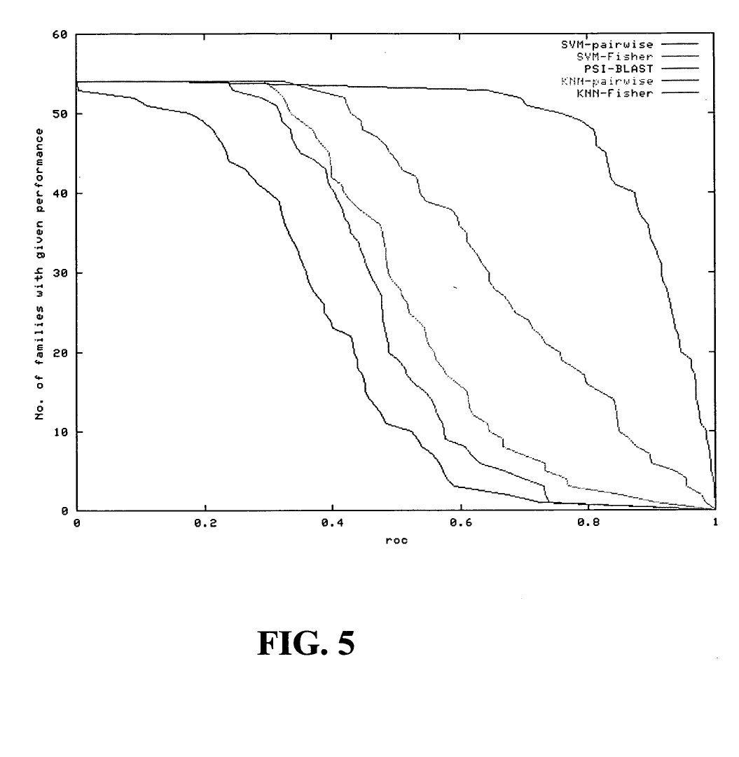

In addition, two variants of the SVM-pairwise algorithm were tested. First, in order to evaluate the benefit provided by the negative examples in the pairwise score vector, a version of SVM-pairwise in which the negative training set is not used during the creation of the score vectors was used (SVM-pairwise⁺). In SVM-pairwise⁺ the negative training set is still used during the training of the SVM (see Table 1 above). In addition, to evaluate the ability of other discriminative classification algorithms to be used in place of SVM, a KNN-pairwise algorithm was also tested. In KNN-pairwise replaces the SVM algorithm with a simpler discriminative classifier, the k-nearest neighbor algorithm. The KNN algorithm takes as input the same feature vector as the SVM does in SVM-pairwise. However, rather than classifying query sequence(s) by orienting them with respect to a separating plane, KNN locates the k training set proteins that are nearest to the query set sequences (using Euclidean distances between vectors). A kernel version of k-nearest neighbor, with the same kernel function as in SVM was used. For the kernel version of KNN, the Euclidean distance between two points X and Y is computed using \sgrt {K(X,X)−2K(X,Y)+K(Y,Y). Henry, Dr. Noble says that he cannot provide any additional details for KNN than what is provided here. The predicted classification is simply the majority classification among these k neighbors. In the present example, k=3 was used. Sequences were ranked according to the number of distance-weighted votes for the positive class. FIG. 5 shows that KNN-pairwise performs better than KNN-fisher. The p-value for KNN-pairwise versus KNN-fisher is 0.00086, which indicates that there is a significant improvement by KNN-pairwise over KNN-Fisher. While this value is not as significant as for SVM-pairwise versus SVM-Fisher (which has a P-value of 0.0000000033), it is still extremely significant.

Each of the above-discussed seven algorithms produce as output a ranking of the query set sequences. To measure the quality of the ranking, two different scores were used: receiver operating characteristic (ROC) scores and the median rate of false positives (RFP). The ROC score is the normalized area under a curve that plots true positives as a function of false positives for varying classification thresholds. See Gribskov & Robinson. Use of receiver operating characteristic (ROC) analysis to evaluate sequence matching. Computers and Chemistry 20:25-33 (1996). A perfect classifier that puts all the positives at the top of the rank list will receive an ROC score of 1, and for these data, a random classifier will receive and ROC score very close to 0. The median RFP score is the fraction of negative query sequences that score as high or better than the median-scoring positive query sequence. RFP scores were used by Jaakkola et al. in evaluating the SVM-Fisher algorithm.

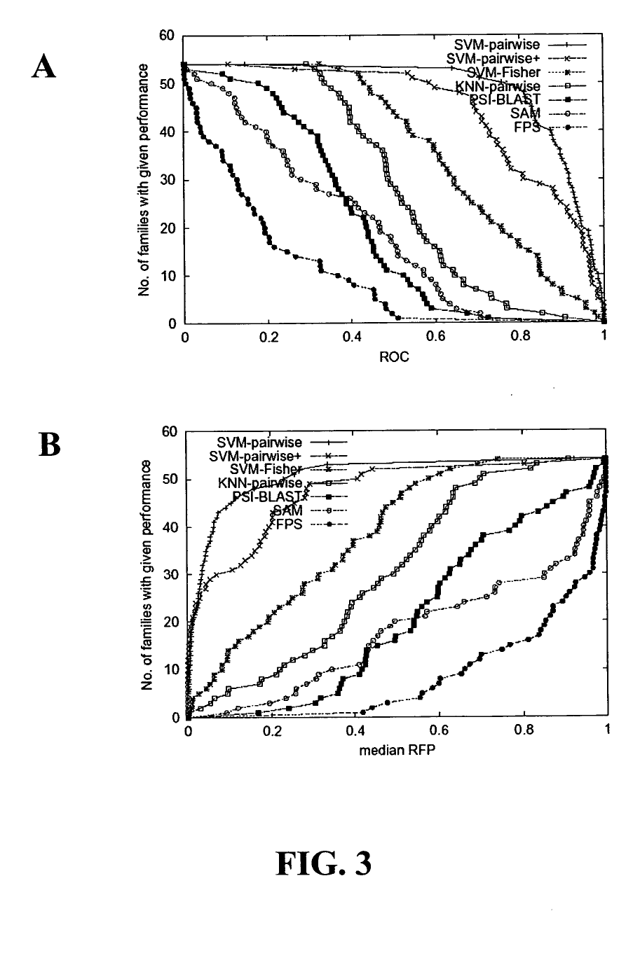

Results: The results of the testing of the seven above discussed algorithms are summarized in FIGS. 3A and 3B. The two graphs of FIGS. 3A and 3B rank the seven homology detection algorithms according to ROC (FIG. 3A) and RFP (FIG. 3B) scores. In each graph, a higher curve corresponds to more accurate homology detection performance. Using either performance measure, the SVM-pairwise and SVM-pairwise⁺ algorithms perform significantly better than the previously known algorithms, including the SVM-Fisher algorithm which is currently believed to be the most accurate homology detection algorithm. Furthermore, as noted above, KNN-pairwise performs better than KNN-Fisher (see FIG. 5)

The statistical significance of the differences among methods was assessed using a two-tailed signed rank test. See Henikoff & Henikoff, “Embedding strategies for effective use of information from multiple sequence alignments,” Protein Science 6:698-705 (1997); and Salzberg, “on comparing classifiers: Pitfalls to avoid and recommended approach,” Data Mining and Knowledge Discovery 1:317-328 (1997). Table 3 shows the statistical significances between pairs of homology detection methods. Each entry in Table 3 is the p-value given by a two-tailed signed rank test (see Zar, Biostatistical Analysis 4th Edition, Prentice Hall (Upper Saddle River, N.J.) 1999, page 123.) comparing paired ROC scores from two methods for each of the 54 families. The p-values have been (conservatively) adjusted for multiple comparisons using a Bonferonni adjustment (Westfall & Young, Resampling-based multiple testing, Wiley (N.Y.) 1993, page 44). An entry in the table indicates that the method listed in the current row performs significantly better than the method listed in the current column. A “-” indicates that the p-value is greater than 0.05, which is a generally agreed upon standard. The statistics for the median RFP scores were similar to the statistics for the ROC scores that are shown in Table 4. As shown in Table 3 below, nearly all of the differences apparent in FIG. 3 are statistically significant at a threshold of 0.05.

TABLE 3

| | SVM- | SVM- | KNN- | PSI- | | |
|---|---|---|---|---|---|---|
| | pairwise+ | Fisher | Pairwise | BLAST | SAM | FPS |
| SVM- | — | 7.8e−08 | 9.6e−09 | 4.6e−09 | 9.1e−09 | 4.6e−09 |
| pairwise | | | | | | |
| SVM- | | 1.9e−03 | 1.7e−07 | 1.2e−08 | 7.3e−09 | 3.5e−09 |
| SVM- | | | 2.5e−05 | 3.3e−08 | 1.4e−05 | 4.6e−09 |
| Fisher | | | | | | |
| KNN- | | | | 2.3e−07 | 2.2e−03 | 9.1e−09 |
| pairwise | | | | | | |
| PSI- | | | | | — | 1.1e−06 |
| BLAST | | | | | | |
| SAM | | | | | | 8.7e−06 |

Only the differences between PSI-BLAST and SAM and between SVM-pairwise and SVM-pairwise⁺ were not statistically significant. Many of these results agree with previously reported assessments. For example, the relative performance of SVM-Fisher and SAM and the poor performance of the FPS algorithm on this task, as shown in Table 3, agrees with the results shown by Jaakkola, Deikhans & Haussler, “Using the Fisher kernel method to detect remote protein homologies,” Proceedings of the Seventh International Conference on Intelligent Systems for Molecular Biology, pages 149-158, Menlo Park, Calif. 91999) AAAI Press. The poor performance of the FPS algorithm is likely due to the difficulty of the recognition task. A previous assessment, which found FPS to be competitive with profile HMMs, tested both algorithms on much less remote homologies. See Grundy, “Family-based homology detection via pairwise sequence comparison,” S. Istrail, P. Pevzner, and M Waterman, editors, Proceedings of the Second Annual International Conference on Computational Molecular Biology, pages 94-100, ACM, 1998. The FPS algorithm can be improved by using Smith-Waterman p-values, rather than BLAST, and by computing p-values for sequence-to-family comparisons. See Baily & Grundy, “Classifying proteins by family using the product of correlated p-values,” S. Istrail, P. Pevzner, and M. Waterman, editors, Proceedings of the Third Annual International Conference on Computational Molecular Biology, pages 10-14. ACM, April 1999. However, these improvements are likely not to make the algorithm competitive with the best algorithms shown herein.

Surprisingly, as seen in FIGS. 3A and 3B, SAM and PSI-BLAST have a comparable relative ranking, as evidenced by the two lines of the graph crossing each other. Previous reports indicated that SAM significantly out performs PSI-BLAST. See Park et al. Sequence comparisons using multiple sequences detect three times as many remote homologues as pairwise methods. Karplus et al., “Sequence comparisons using multiple sequences detect three times as many remote homologues as pairwise methods,” Journal of Molecular Biology, 284:1201-1210 (1998). It is possible that in the current examples, the SAM software was improperly used such that parameters were set differently than an expert in SAM would have set. To reduce the likelihood of this possibility, the experiment was repeated using CLUSTAL W [Thompson, Higgins & Gibson, “CLUSTAL W: Improving the sensitivity of progressive multiple sequence alignment through sequence weighting, position specific gap penalties and weight matrix choice,” Nucleic Acids Research 22:4673-4680 (1994)] to align the sequences and HMMER [Eddy, “Multiple alignment using Hidden Markov models.,” C. Rawings, editor, Proceedings of the Third International Conference on Intelligent Systems for Molecular Biology, pages 114-120, AAAI Press, 1995] to build models and score them. The resulting ROC and median RFP scores were very similar to the scores produced by SAM: i.e. the two sets of scores were not statistically significantly different from one another nor from PSI-BLAST scores. The benefit of using SAM may be further improved in the context of an iterative search, as was used by Park et al., “SCOP: A structural classification of protein database for the investigation of sequences and structures,” Journal of Molecular Biology, 284:1201-1210 (1998). It is also possible that a statistical difference between SAM and PSI-BLAST was not seen herein because the PSI-BLAST algorithm has been considerably improved in the last several years and it may now perform as well as SAM, at least in the experiments described herein.

As noted above, the SVM-pairwise⁺ algorithm performs nearly as well as the SVM-pairwise algorithm. This result implies that the power of SVM-pairwise does not lie entirely in the use of the negative training set during vectorization. Given the large size of the negative training set, the SVM-pairwise⁺ algorithm is considerably faster than SVM-pairwise and therefore provides a powerful, efficient alternative.

The placement of the KNN-pairwise algorithm above PSI-BLAST and below SVM-Fisher is significant in several respects. The result shows that the pairwise sequence similarity algorithm brings considerable power to the method, resulting in a powerful method for detecting remote sequence homologies using a very simple classification algorithm. The results shown in FIG. 5 show that any discriminative classifier may be used in accordance with the present invention. Furthermore, these results indicate that a preferred embodiment of the present invention is the use of the SVM algorithm. KNN-pairwise may be improved using a generalization such as Parzen windows [Bishop, Neural Networks for Pattern Recognition, Oxford UP, Oxford, UK, 1995].

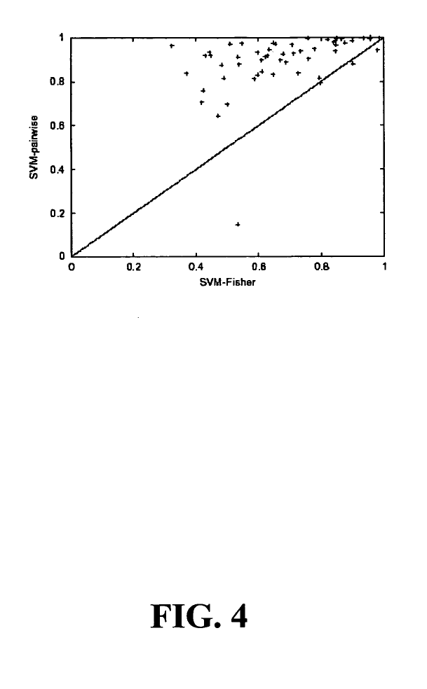

The experiments shown herein indicate that the SVM-pairwise is the best performing algorithm and is therefore preferred. FIG. 4 further illustrates the performance of the SVM-pairwise algorithm. FIG. 4 shows a family-by-family comparison of the 54 ROC scores computed SVM-pairwise and SVM-Fisher. Each axis of FIG. 4 is the receiver operating characteristic (ROC) score, which is calculated by plotting the number of true positives as a function of the number of false positives for varying classification thresholds, and then taking the normalized area under the resulting curve. An ROC score of 1.0 corresponds to a classifier that perfectly separates positive from negative examples. The SVM-pairwise algorithm scores higher than the SVM-Fisher method on nearly every family. The one outlier is family 2.44.1.2, which has a relatively small training set. Family-by-family results from each of the seven methods (data not shown) also showed that SVM-pairwise out performed other methods.

As with the SVM-Fisher algorithm, SVM-pairwise exploits a negative training set to yield more accurate predictions. Unlike SVM-Fisher however, SVM-pairwise can extend this discriminative component into the vectorization step. The inclusion of the negative examples in the vectorization step adds another degree of power to the algorithm. Another difference lies in the method by which sequences are converted into vector form. The vector of pairwise similarity scores relaxes the requirement for a multiple alignment of the training set sequences. This difference may explain the improved performance seen with SVM-pairwise over SVM-Fisher. The SVM-pairwise algorithm is not however more computationally efficient than the SVM-Fisher algorithm. Both algorithms include an SVM optimization, which is roughly O(n²), where it is the number of training set examples. The vectorization step of SVM-Fisher requires training a profile HMM and computing the gradient vectors. The gradient computation dominates with a running time of O(nmp), where m is the length of the longest training set sequence, and p is the number of HMM parameters. In contrast, the vectorization step of SVM-pairwise involves computing n² pairwise scores. Using Smith-Waterman, each computation is O(m²), yielding a total running time of O(n²m²). Thus, assuming that m p, the SVM-pairwise vectorization takes approximately n times as long as the SVM-Fisher vectorization.

It is possible to increase the speed at which the SVM-pairwise algorithm works. For example, the vectorization step may be carried out using a linear time approximation of Smith-Waterman, such as BLAST. This modification immediately removes a factor of in from the running time, although the change may presumably decrease the accuracy of the algorithm. In addition, an explicit “vectorization set” of sequences for creating the feature vectors could be used. In the current examples, the SVM-pairwise algorithm compares each training and query sequence set sequence to every sequence in the training set. There is no reason, however, that the columns of the vector matrix must correspond to the training set sequences. A relatively small collection of widely distributed sequences (or even a library of profile HMMs) may provide a powerful, concise vector signature of any given sequence.

Another alternative to the SVM-pairwise algorithm is to build the similarity score directly into the SVM. Previously described methods have derived kernel functions that allow direct comparison of strings. See, e.g., Watkins, “Dynamic alignment kernels,” A. J. Smola, P. Bartlett, B. Schölkopf and C. Schuurmans, editors, Advances in Large Margin Classifiers. MIT Press, 1999; Haussler, “Convolution kernels on discrete structures,” Technical Report UCSC-CRL-99-99-10, University of California, Santa Cruz, Calif., July 1999; and Leslie, Eskin and Noble, “The spectrum kernel: A string kernel for SVM protein classification,” Proceedings of the Pacific Symposium on Biocomputing, 2002, pp 474-485, published by World Scientific, River Edge, N.J.

While the present invention has been described by way of examplary embodiments thereof, various modifications and alterations to the disclosed embodiments will be apparent to those skilled in the art without departing from the spirit and scope of the invention, the scope of the present invention being defined by the appended claims.

1. A method for identifying functionally similar proteins by determining whether a second protein is homologous to a first protein, where the sequence and function of the first protein are known, comprising:
(a) providing a training sequence set of positive and negative examples, wherein a positive example is a protein sequence defined as homologous to the sequence of the first protein and a negative example is a protein sequence defined as non-homologous to the sequence of the first protein wherein each positive and each negative example is assigned a corresponding binary label,
(b) providing the protein sequence of the second protein;
(c) converting each sequence in the training sequence set into respective fixed-length vectors of real values by computing pairwise sequence similarity scores with respect to a vectorization sequence set to obtain pairwise vector scores each having a corresponding binary label;
(d) training a discriminative classification algorithm with the vectorized sequences and the corresponding binary labels to obtain a trained discriminative classification algorithm;
(e) converting the protein sequence of the second protein into a score vectors with respect to the vectorization sequence set to obtain a vectorized sequences; and
(f) applying the trained discriminative classification algorithm to the vectorized sequences of step (e) to produce a predicted classifications as a score vector having a positive or negative value, wherein if the score vector value is positive the second protein is homologous to the first protein and is more likely to share a common function with the first protein.

2. The method of claim 1, wherein the sequence of the second protein is comprised among a plurality of protein sequences.

3. The method of claim 1 or 2, wherein the training sequence set and the vectorization sequence set are the same.

4. The method of claim 1 or 2, wherein the discriminative classification algorithm is selected from the group consisting of an Support Vector Machine (SVM) algorithm and a k-nearest neighbor (KNN) algorithm.

5. The method of claim 4, wherein the discriminative classification algorithm is the (SVM) algorithm.

6. The method of claim 1 or 2, wherein the pairwise sequence similarity algorithm is selected from the group consisting of Smith-Waterman, BLAST and FASTP.

7. The method of claim 6, wherein the pairwise sequence similarity algorithm is Smith-Waterman

8. A method for identifying, from among a plurality of proteins represented in a protein sequence database a second protein homologous to a first protein where the sequence and function of the first protein are known comprising:
(a) providing a training sequence set of positive and negative examples, wherein a positive example is a protein sequence defined as homologous to the sequence of the first protein and a negative example is a protein sequence defined as non-homologous to the sequence of the first protein wherein each positive and each negative example is assigned a corresponding binary label;
(b) providing a protein sequence database comprising a plurality of protein sequences;
(c) converting each sequence in the training sequence set into respective fixed-length vectors of real values by computing pairwise sequence similarity scores with respect to a vectorization sequence set to obtain pairwise vector scores each having a corresponding binary label;
(d) training a discriminative classification algorithm with the vectorized sequences and the corresponding binary labels to obtain a trained discriminative classification algorithm:
(e) converting protein sequences in the protein sequence database into Pairwise score vectors with respect to the vectorization sequence set to obtain vectorized database sequences; and
(f) applying the trained discriminative classification algorithm to the vectorized database sequences of step (e) to produce respective predicted classifications for the database query sequences as score vectors having positive or negative values:
wherein a protein sequence having a positive score vector value represents a second protein homologous to the first protein.

9. The method of claim 8, wherein the training sequence set and the vectorization sequence set are the same.

10. The method of claim 8, wherein the discriminative classification algorithm is selected from the group consisting of an Support Vector Machine (SVM) algorithm and a k-nearest neighbor (KNN) algorithm.

11. The method of claim 10, wherein the discriminative classification algorithm is the SVM algorithm.

12. The method of claim 8, wherein the pairwise sequence similarity algorithm is selected from the group consisting of Smith-Waterman, BLAST and FASTP.

13. The method of claim 12, wherein the pairwise sequence similarity algorithm is Smith-Waterman.

14. A method for identifying functionally similar proteins by determining whether a second protein is homologous to a first protein, where the sequence and function of the first protein are known, comprising:
(a) providing a training sequence set comprising positive examples, wherein a positive example is a protein sequence defined as homologous to the sequence of the first protein, wherein each positive example is assigned a corresponding binary label;
(b) providing the protein sequence of the second protein;
(c) converting each sequence in the training sequence set into respective fixed-length vectors of real values by computing pairwise sequence similarity scores with respect to a vectorization sequence set to obtain pairwise vector scores each having a corresponding binary label;
(d) training a discriminative classification algorithm with the vectorized sequences and the corresponding binary labels to obtain a trained discriminative classification algorithm;
(e) converting the protein sequence of the second protein into a score vector with respect to the vectorization sequence set to obtain a vectorized sequence; and
(f) applying the trained discriminative classification algorithm to the vectorized sequence of step (e) to produce a predicted classification as a score vector; wherein if the score vector value is positive, the second protein is homologous to the first protein and is more likely to share a common function with the first protein.

15. The method of claim 14, wherein the sequence of the second protein is comprised among a plurality of protein sequences.

16. The method of claim 14 or 15, wherein the training sequence set and the vectorization sequence set are the same.

17. The method of claim 14 or 15, wherein the discriminative classification algorithm is selected from the group consisting of an Support Vector Machine (SVM) algorithm and a k-nearest neighbor (KNN) algorithm.

18. The method of claim 17, wherein the discriminative classification algorithm is the SVM algorithm.

19. The method of claim 14 or 15, wherein the pairwise sequence similarity algorithm is selected from the group consisting of Smith-Waterman, BLAST and FASTP.

20. The method of claim 19, wherein the pairwise sequence similarity algorithm is Smith-Waterman.

21. A method for identifying functionally similar nucleic acids by determining whether a second nucleic acid is homologous to a first nucleic acid, where the sequence and function of the first nucleic acid are known, comprising:
(a) providing a training sequence set of positive and negative examples, wherein a positive example is a nucleic acid sequence defined as homologous to the sequence of the first nucleic acid and a negative example is a nucleic acid sequence defined as non-homologous to the sequence of the first nucleic acid, wherein each positive and each negative example is assigned a corresponding binary label;
(b) providing the sequence of the second nucleic acid;
(c) converting each sequence in the training sequence set into respective fixed-length vectors of real values by computing pairwise sequence similarity scores with respect to a vectorization sequence set to obtain pairwise vector scores each having a corresponding binary label;
(d) training a discriminative classification algorithm with the vectorized sequences and the corresponding binary labels to obtain a trained discriminative classification algorithm;
(e) converting the sequence of the second nucleic acid into a score vector with respect to the vectorization sequence set to obtain a vectorized sequence; and
(f) applying the trained discriminative classification algorithm to the vectorized sequence of step (e) to produce a predicted classification as a score vector having a positive or negative value;
wherein if the score vector value is positive, the second nucleic acid is homologous to the first nucleic acid and is more likely to share a common function with the first nucleic acid.

22. The method of claim 21, wherein the sequence of the second nucleic acid is comprised among a plurality of nucleic acid sequences.

23. The method of claim 21, wherein the nucleic acid is DNA.

24. The method of claim 22, wherein the nucleic acid is DNA.

25. The method of claim 21, wherein the nucleic acid is RNA.

26. The method of claim 22, wherein the nucleic acid is RNA.

27. The method of claim 21, 22, 23, 24, 25 or 26, wherein the training sequence set and the vectorization sequence set are the same.

28. The method of claim 21, 22, 23, 24, 25 or 26, wherein the discriminative classification algorithm is selected from the group consisting of an Support Vector Machine (SVM) algorithm and a k-nearest neighbor (KNN) algorithm.

29. The method of claim 28, wherein the discriminative classification algorithm is the SVM algorithm.

30. The method of claim 21, 22, 23, 24, 25 or 26, wherein the pairwise sequence similarity algorithm is selected from the group consisting of Smith-Waterman, BLAST and FASTP.

31. The method of claim 30, wherein the pairwise sequence similarity algorithm is Smith-Waterman.

32. A method for identifying, from among a plurality of nucleic acids represented in a nucleic acid sequence database, a second nucleic acid homologous to a first nucleic acid, where the sequence and function of the first nucleic acid are known, comprising:
(a) providing a training sequence set of positive and negative examples, wherein a positive example is a nucleic acid sequence defined as homologous to the sequence of the first nucleic acid and a negative example is a nucleic acid sequence defined as non-homologous to the sequence of the first nucleic acid, wherein each positive and each negative example is assigned a corresponding binary label;
(b) providing a nucleic sequence database comprising a plurality of nucleic acid sequences;
(c) converting each sequence in the training sequence set into respective fixed-length vectors of real values by computing pairwise sequence similarity scores with respect to a vectorization sequence set to obtain pairwise vector scores each having a corresponding binary label;
(d) training a discriminative classification algorithm with the vectorized sequences and the corresponding binary labels to obtain a trained discriminative classification algorithm;
(e) converting nucleic acid sequences in the nucleic acid sequence database into pairwise score vectors with respect to the vectorization sequence set to obtain vectorized database sequences; and
(f) applying the trained discriminative classification algorithm to the vectorized database sequences of step (e) to produce respective predicted classifications for the database query sequences as score vectors having positive or negative values;
wherein a nucleic acid sequence having a positive score vector value represents a second nucleic acid homologous to the first nucleic acid.

33. The method of claim 32 wherein the nucleic acid is DNA.

34. The method of claim 32, wherein the nucleic acid is RNA.

35. The method of claim 32, wherein the training sequence set and the vectorization sequence set are the same.

36. The method of claim 32, wherein the discriminative classification algorithm is selected from the group consisting of an Support Vector Machine (SVM) algorithm and a k-nearest neighbor (KNN) algorithm.

37. The method of claim 36, wherein the discriminative classification algorithm is the SVM algorithm.

38. The method of claim 32, wherein the pairwise sequence similarity algorithm is selected from the group consisting of Smith-Waterman, BLAST and FASTP.

39. The method of claim 38, wherein the pairwise sequence similarity algorithm is Smith-Waterman.

40. A method for identifying functionally similar nucleic acids by determining whether a second nucleic acid is homologous to a first nucleic acid, where the sequence and function of the first nucleic acid are known, comprising:
(a) providing a training sequence set comprising positive examples, wherein a positive example is a nucleic acid sequence defined as homologous to the sequence of the first nucleic acid, wherein each positive example is assigned a corresponding binary label;
(b) providing the nucleic acid sequence of the second nucleic acid;
(c) converting each sequence in the training sequence set into respective fixed-length vectors of real values by computing pairwise sequence similarity scores with respect to a vectorization sequence set to obtain pairwise vector scores each having a corresponding binary label;
(d) training a discriminative classification algorithm with the vectorized sequences and the corresponding binary labels to obtain a trained discriminative classification algorithm;
(e) converting the nucleic acid sequence of the second nucleic acid into a score vector with respect to the vectorization sequence set to obtain a vectorized sequence; and
(f) applying the trained discriminative classification algorithm to the vectorized sequence of step (e) to produce a predicted classification as a score vector; wherein if the score vector value is positive, the second nucleic acid is homologous to the first nucleic acid and is more likely to share a common function with the first nucleic acid

41. The method of claim 40, wherein the sequence of the second nucleic acid is comprised among a plurality of nucleic acid sequences.

42. The method of claim 40, wherein the nucleic acid is DNA.

43. The method of claim 41, wherein the nucleic acid is DNA.

44. The method of claim 40, wherein the nucleic acid is RNA.

45. The method of claim 41, wherein the nucleic acid is RNA.

46. The method of claim 40, wherein the training sequence set and the vectorization sequence set are the same.

47. The method of claim 40, wherein the discriminative classification algorithm is selected from the group consisting of an Support Vector Machine (SVM) algorithm and a k-nearest neighbor (KNN) algorithm.

48. The method of claim 47, wherein the discriminative classification algorithm is the SVM algorithm.

49. The method of claim 40, wherein the pairwise sequence similarity algorithm is selected from the group consisting of Smith-Waterman, BLAST and FASTP.

50. The method of claim 49, wherein the pairwise sequence similarity algorithm is Smith-Waterman.
